(19) United States
(12) Patent Application Publication
(10) Pub. No.: US 2014/0343235 A1
(43) Pub. Date: Nov. 20, 2014

(54) Aluminum-Polymer Resin Composite And Method For Producing The Same

(71) Applicants: Korea Basic Science Institute, Daejeon (KR); Taesung Politech Co. Ltd., Busan (KR)

(72) Inventors: Euh Duck Jeong, Gyeongsangnam-do (KR); Eun Kyung Jang, Gyeongsangnam-do (KR); Tae Eun Hong, Busan (KR); Mi Rang Byeon, Busan (KR); Jong Pil Kim, Busan (KR); Jong Seong Bae, Busan (KR); Jong Sung Jin, Gyeongsangnam-do (KR); Hong Dae Jung, Busan (KR); Su Jong Lee, Busan (KR)

(21) Appl. No.: 14/373,706

(22) PCT Filed: Mar. 20, 2013
(86) PCT No.: PCT/KR2013/002308

§ 371 Date: Jul. 22, 2014

(30) Foreign Application Priority Data
Mar. 21, 2012 (KR) 10-2012-0028570

(51) Int. Cl. C25D 5/34; C25D 5/48; C08G 75/16

(52) U.S. Cl. CPC C25D 5/34; C08G 75/16; C25D 5/48
USPC 525/537; 205/211

(57) ABSTRACT

Disclosed is an aluminum-polymer resin composite. The composite includes i) aluminum and ii) a polymer resin bonded to the aluminum after modification of the aluminum surface with at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents. The intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS). The composite has improved adhesive strength between the metal and the resin while maintaining its tensile strength and air tightness even after thermal shock testing. The composite is produced through various processing steps, including pretreatment, appropriate surface roughening, thermal treatment and surface coating, to enhance the bonding strength between the metal and the resin. The use of compounds containing S, N and Si further increases the bonding strength between the metal and the resin.

### TECHNICAL FIELD

The present invention relates to an aluminum-polymer resin composite and a method for producing the same. More specifically, the present invention relates to an aluminum-polymer resin in which the aluminum surface is modified by treatment with an acid and is appropriately roughened by chemical oxidation or is thermally treated at an optimum temperature to achieve improved adhesive strength to the polymer, and a method for producing the composite.

### BACKGROUND ART

According to a general method for attaching or adhering a plastic material to the surface of a base metal such as aluminum, copper, magnesium or iron, the surface of the base metal is coated with another metal such as Si or Ti and a thermoplastic resin as the plastic material is adhered to the coated metal surface using the bonding strength to oxygen. Alternatively, an adhesive such as an epoxy functional silane compound resin may be used to adhere the plastic material to the base metal.

Japanese Patent Publication No. 1993-051671 discloses a method for forming a coating film of a triazine thiol on a metal surface by an electrochemical surface modification process such as electrodeposition. Japanese Patent Publication No. 2001-200374 discloses an exemplary method for retaining the reactivity of a metal by adsorbing a triazine thiol metal salt to the metal surface or by reacting with the triazine thiol metal salt to negatively charge the metal surface. However, these patent publications fail to sufficiently describe the bonding strength at the interface between an aluminum component and a resin.

According to published research reports, triazine thiol derivatives are introduced on metal surfaces and are polymerized by suitable processes such as thermal, photochemical, UV irradiation, and electrochemical processes to inhibit or prevent the corrosion of the metals (K. Mori et al., Langmuir, 7, 1161-1166, 1991; H. Baba et al., Corrosion Science, 39, 3, 555-564, 1997; Baba et al., Corrosion Science, 41, 1898-2000, 1999).

The effects of introducing thiol derivatives on magnesium alloy surfaces are also known (K. Mori et al., Materials Science Forum, 350-351, 223-234, 2000). A report was published concerning the bonding of PPS to magnesium alloys through coating of triazine thiol derivatives (Z. Kang et al, Surface & Coating Technology, 195, 162-167, 2005).

Korean Patent Publication No. 2010-0082854 discloses a priming agent for a metal material and a method for priming a metal material. The method uses an oxidizing agent, and the priming agent contains an elastomer having one or more benzene nuclei and one or more functional groups selected from the group consisting of hydroxyl, carboxyl and amino groups. Further, U.S. Patent Publication No. 2010-0279108, which was recently published, describes a technique for improving the adhesion between an aluminum component and a resin. In this patent publication, the thickness of an anodic oxide coating or the thickness of an anodic oxide coating including a triazine thiol is numerically limited to 70 to 1500 nm, and the intensity of OH group in the infrared absorption spectrum of the anodic oxide coating is numerically limited to 0.0001 to 0.16.

Research on aluminum anodic oxidation (AAO) has been conducted based on the processing of various oxides into nanotubes. However, control over the thickness of anodic oxide coating or the intensity of OH group alone is insufficient in improving the bonding strength between aluminum and resins.

### DISCLOSURE

### Technical Problem

The present invention has been made in an effort to solve the above problems, and it is an object of the present invention to provide an aluminum-polymer resin composite in which the aluminum surface is modified with sulfur-containing compounds to improve the adhesive strength between the metal and the resin, achieving improved tensile strength while maintaining the tensile strength even after a thermal shock.

It is another object of the present invention to provide a method for producing an aluminum-polymer resin composite in which at least one sulfur-containing surface modifier forms various bonds between the aluminum and the polymer resin to improve the adhesive strength between the metal and the polymer resin, achieving improved tensile strength while maintaining the tensile strength even after a thermal shock.

### Technical Solution

One aspect of the present invention provides an aluminum-polymer resin composite including:

i) aluminum; and

ii) a polymer resin bonded to the aluminum after modification of the aluminum surface with at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents,

wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS).

Another aspect of the present invention provides a method for producing an aluminum-polymer resin composite, including:

i) degreasing aluminum as a base and treating the degreased aluminum with an acid to roughen the aluminum surface;

ii) subjecting the surface-roughened aluminum to electrochemical anodic oxidation to form an appropriate nanoporous surface structure;

iii) applying to the aluminum oxide at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents; and

iv) injection molding a polymer resin on the surface-modified aluminum,

wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS).

### Advantageous Effects

The composite of the present invention has improved adhesive strength between the metal and the resin while maintaining its tensile strength and air tightness even after thermal shock testing. According to the method of the present invention, various processing steps, including pretreatment, appropriate surface roughening, thermal treatment and surface coating, are carried out to enhance the bonding strength between the metal and the resin. The use of compounds containing S, N and Si further increases the bonding strength between the metal and the resin.

### DESCRIPTION OF DRAWINGS

FIG. 1 is a photograph showing a structure in which an aluminum terminal of an aluminum cap plate for a high capacity lithium ion secondary battery was treated and PPS as a polymer was bonded thereto by injection molding in Example 1.

FIGS. 2a and 2b are scanning electron microscopy (SEM) images showing the surface of aluminum after electrochemical anodic oxidation at 30 V for 10 minutes in Example 1.

FIGS. 3a and 3b are scanning electron microscopy (SEM) images showing the surface of aluminum after electrochemical anodic oxidation at 40 V for 10 minutes in Example 2.

FIGS. 4a and 4b are scanning electron microscopy (SEM) images showing the surface of aluminum after electrochemical anodic oxidation at 40 V for 20 minutes in Example 3.

FIGS. 5a and 5b are scanning electron microscopy (SEM) images showing the surface of aluminum after electrochemical anodic oxidation at 40 V for 40 minutes in Example 4.

FIGS. 6a and 6b are scanning electron microscopy (SEM) images showing the surface of aluminum after electrochemical anodic oxidation at 40 V for 20 minutes and electrical application of a 2,5-dimercapto-1,3,4-dithiadiazole derivative for 10 minutes in Example 5.

FIGS. 7a and 7b are scanning electron microscopy (SEM) images showing the surface of aluminum after electrochemical anodic oxidation at 40 V for 20 minutes and electrical application of a 2,5-dimercapto-1,3,4-dithiadiazole derivative for 20 minutes in Example 6.

FIGS. 8a and 8b are scanning electron microscopy (SEM) images showing the surface of aluminum after electrochemical anodic oxidation at 40 V for 20 minutes and electrical application of a 2,5-dimercapto-1,3,4-dithiadiazole derivative for 40 minutes in Example 7.

FIGS. 9a and 9b are scanning electron microscopy (SEM) images showing the surface of aluminum after electrochemical anodic oxidation at 40 V for 20 minutes and application of mercaptopropyltrimethoxysilane as a coupling agent for 20 minutes in Example 8.

FIGS. 10a and 10b are scanning electron microscopy (SEM) images showing the surface of aluminum after electrochemical anodic oxidation at 40 V for 20 minutes and application of mercaptopropyltrimethoxysilane as a coupling agent for 30 minutes in Example 9.

FIGS. 11a and 11b are scanning electron microscopy (SEM) images showing the surface of aluminum after electrochemical anodic oxidation at 40 V for 20 minutes, application of mercaptopropyltrimethoxysilane as a coupling agent for 30 minutes, and electrical application of a 2,5-dimercapto-1,3,4-dithiadiazole derivative for 10 minutes in Example 10.

FIGS. 12a and 12b are scanning electron microscopy (SEM) images showing the surface of aluminum after electrochemical anodic oxidation at 40 V for 20 minutes, application of mercaptopropyltrimethoxysilane as a coupling agent for 30 minutes, and electrical application of a 2,5-dimercapto-1,3,4-dithiadiazole derivative for 30 minutes in Example 11.

FIGS. 13a and 13b are scanning electron microscopy (SEM) images showing the surface of aluminum after acid-base treatment and application of 2,5-dimercapto-1,3,4-dithiadiazole by dipping for 5 minutes in Comparative Example 1.

FIGS. 14a and 14b are scanning electron microscopy (SEM) images showing the surface of aluminum after acid-base treatment, application of 2,5-dimercapto-1,3,4-dithiadiazole by dipping for 5 minutes, and application of mercaptopropyltrimethoxysilane as a coupling agent for 30 minutes in Comparative Example 2.

FIGS. 15a and 15b are scanning electron microscopy (SEM) images showing the surface of aluminum after acid-base treatment, application of 2,5-dimercapto-1,3,4-dithiadiazole by dipping for 10 minutes, and application of mercaptopropyltrimethoxysilane as a coupling agent for 30 minutes in Comparative Example 3.

FIGS. 16a and 16b are scanning electron microscopy (SEM) images showing the surface of aluminum after acid-base treatment, application of 2,5-dimercapto-1,3,4-dithiadiazole by dipping for 20 minutes, and application of mercaptopropyltrimethoxysilane as a coupling agent for 30 minutes in Comparative Example 4.

FIGS. 17a and 17b are scanning electron microscopy (SEM) images showing the surface of aluminum after acid-base treatment in Comparative Example 5.

FIGS. 18a and 18b are scanning electron microscopy (SEM) images showing the surface of aluminum after acid-base treatment and application of mercaptopropyltrimethoxysilane as a coupling agent for 30 minutes in Comparative Example 6.

FIG. 19 shows the results of secondary ion mass spectrometry (SIMS) for an aluminum sample whose surface was modified by electrochemical anodic oxidation at 30 V for 10 minutes in Example 1.

FIG. 20 shows the results of secondary ion mass spectrometry (SIMS) for an aluminum sample whose surface was modified by electrochemical anodic oxidation at 40 V for 10 minutes in Example 2.

FIG. 21 shows the results of secondary ion mass spectrometry (SIMS) for an aluminum sample whose surface was modified by electrochemical anodic oxidation at 40 V for 20 minutes in Example 3.

FIG. 22 shows the results of secondary ion mass spectrometry (SIMS) for an aluminum sample whose surface was modified by electrochemical anodic oxidation at 40 V for 40 minutes in Example 4.

FIG. 23 shows the results of secondary ion mass spectrometry (SIMS) for an aluminum sample whose surface was modified by electrical application of a 2,5-dimercapto-1,3,4-dithiadiazole derivative for 10 minutes in Example 5.

FIG. 24 shows the results of secondary ion mass spectrometry (SIMS) for an aluminum sample whose surface was modified by electrical application of a 2,5-dimercapto-1,3,4-dithiadiazole derivative for 20 minutes in Example 6.

FIG. 25 shows the results of secondary ion mass spectrometry (SIMS) for an aluminum sample whose surface was modified by electrical application of a 2,5-dimercapto-1,3,4-dithiadiazole derivative for 40 minutes in Example 7.

FIG. 26 shows the results of secondary ion mass spectrometry (SIMS) for an aluminum sample whose surface was modified by application of mercaptopropyltrimethoxysilane as a coupling agent for 20 minutes in Example 8.

FIG. 27 shows the results of secondary ion mass spectrometry (SIMS) for an aluminum sample whose surface was modified by application of mercaptopropyltrimethoxysilane as a coupling agent for 30 minutes in Example 9.

FIG. 28 shows the results of secondary ion mass spectrometry (SIMS) for an aluminum sample whose surface was modified by application of mercaptopropyltrimethoxysilane as a coupling agent for 30 minutes and electrical application of a 2,5-dimercapto-1,3,4-dithiadiazole derivative for 10 minutes in Example 10.

FIG. 29 shows the results of secondary ion mass spectrometry (SIMS) for an aluminum sample whose surface was modified by application of mercaptopropyltrimethoxysilane as a coupling agent for 30 minutes and electrical application of a 2,5-dimercapto-1,3,4-dithiadiazole derivative for 30 minutes in Example 11.

FIG. 30 shows the results of secondary ion mass spectrometry (SIMS) for an aluminum sample whose surface was modified by acid-base treatment and application of 2,5-dimercapto-1,3,4-dithiadiazole by dipping for 5 minutes in Comparative Example 1.

FIG. 31 shows the results of secondary ion mass spectrometry (SIMS) for an aluminum sample whose surface was modified by acid-base treatment, application of 2,5-dimercapto-1,3,4-dithiadiazole by dipping for 5 minutes, and application of mercaptopropyltrimethoxysilane as a coupling agent for 30 minutes in Comparative Example 2.

FIG. 32 shows the results of secondary ion mass spectrometry (SIMS) for an aluminum sample whose surface was modified by acid-base treatment, application of 2,5-dimercapto-1,3,4-dithiadiazole by dipping for 10 minutes, and application of mercaptopropyltrimethoxysilane as a coupling agent for 30 minutes in Comparative Example 3.

FIG. 33 shows the results of secondary ion mass spectrometry (SIMS) for an aluminum sample whose surface was modified by acid-base treatment, application of 2,5-dimercapto-1,3,4-dithiadiazole by dipping for 20 minutes, and application of mercaptopropyltrimethoxysilane as a coupling agent for 30 minutes in Comparative Example 4.

FIG. 34 shows the results of secondary ion mass spectrometry (SIMS) for an aluminum sample whose surface was modified by acid-base treatment in Comparative Example 5.

FIG. 35 shows the results of secondary ion mass spectrometry (SIMS) for an aluminum sample whose surface was modified by acid-base treatment and application of mercaptopropyltrimethoxysilane as a coupling agent for 30 minutes in Comparative Example 6.

### MODE FOR INVENTION

The present invention will now be described in detail.

The present invention provides an aluminum-polymer resin including i) aluminum and ii) a polymer resin bonded to the aluminum after modification of the aluminum surface with at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS).

In the composite of the present invention including the coated surface modifier, a mixture of S, N, O, C, Na, and Si is diffused on an aluminum oxide. Particularly, the results of secondary ion mass spectrometry (SIMS) for the composite show that the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm. These values indicate the presence of S, N, O, C, Na, and Si in appropriate amounts even at considerable depths of the composite.

Secondary ion mass spectrometry (SIMS) for the composite reveals that the intensity ratio of C/Al is preferably from 1.1×10⁻³ to 6.0×10⁻³, the intensity ratio of N/Al is preferably from 4.2×10⁻⁵ to 4.2×10⁻⁴, the intensity ratio of O/Al is preferably from 1.7×10⁻¹ to 3.1×10⁻¹, the intensity ratio of Na/Al is preferably from 2.1×10⁻³ to 9.5×10⁻¹, the intensity ratio of Si/Al is preferably from 6.3×10⁻⁵ to 4.2×10⁻⁴, and the intensity ratio of S/Al is preferably from 9.7×10⁶ to 7.8×10⁴.

The surface modifier may be polymerized into a one-, two- or three-dimensional polymer containing S and N. Specifically, the one-dimensional (linear) polymer may be, for example, a polymer of a 2,5-dimercapto-1,3,4-thiadiazole derivative, dithiopiperazine or dimethylethylenediamine. The two-dimensional (ladder) polymers may be, for example, a polymer of tetrathioethylenediamine or polyethyleneimine dithiol. The three-dimensional (cross-linked) polymer is preferably a polymer of a triazine thiol derivative or a 2,4-dithiopyrimidine derivative. A Si-containing polymer, for example, a polymer of mercaptopropylmethoxysilane, may also be used.

The polymers of a 2,5-dimercapto-1,3,4-thiadiazole derivative, dithiopiperazine and dimethylethylenediamine as one-dimensional (linear) polymers may be represented by the following respective formulae:

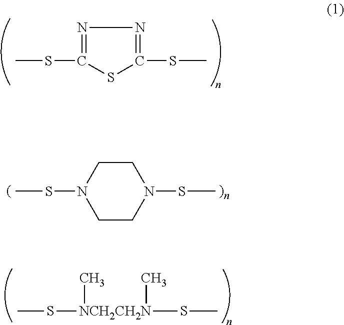

wherein each n is an integer from 10 to 100.

The polymers of tetrathioethylenediamine and polyethyleneimine dithiol as two-dimensional (ladder) polymers may be represented by the following respective formulae:

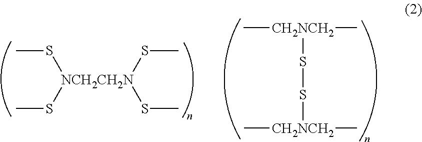

wherein each n is an integer from 10 to 100.

The triazine thiol derivative and the 2,4-dithiopyrimidine derivative polymerizable into three-dimensional (cross-linked) polymers may be represented by the following respective formulae:

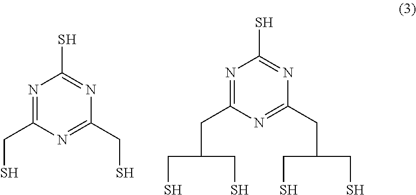 [SMILES: SCc1nc(S)nc(CS)n1 ; SCC(CS)Cc1nc(S)nc(CC(CS)CS)n1]

wherein each of the upper SH groups may be substituted with one or more functional group selected from the group consisting of 6-allylamino, 6-dibutylamino, 6-diallylamino, 6-dithiooctylamino, 6-dilaurylamino, 6-stearylamino, and 6-oleylamino. The same SH substitution may apply to Formulae 1, 2 and 4.

The polymer of the dithiopyrimidine derivative is preferably represented by Formula 4:

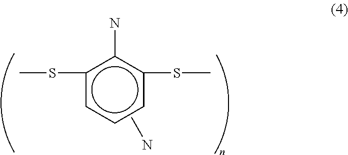

wherein

n is an integer from 10 to 100,

S may be substituted with —SM, —OR¹, —SR¹, —NHR¹ or —N(R¹)₂,

M is H, Na, Li, K, an aliphatic primary, secondary or tertiary amine, or a quaternary ammonium, and

R¹ may be at least one group selected from the group consisting of alkyl, alkenyl, phenyl, phenylalkyl, alkylphenyl, and cycloalkyl groups.

The physical properties of the composite according to the present invention can be confirmed using a secondary ion mass spectrometer (SIMS) based on the MCs⁺ cluster method for the detection of Cs⁺ primary ions and positive secondary ions.

A further embodiment of the present invention provides a method for producing an aluminum-polymer resin composite, the method including i) degreasing aluminum as a base and treating the degreased aluminum with an acid to roughen the aluminum surface, ii) subjecting the surface-roughened aluminum to electrochemical anodic oxidation to form an appropriate nanoporous surface structure, iii) applying to the aluminum oxide at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents, and iv) injection molding a polymer resin on the surface-modified aluminum wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS).

Hereinafter, the method of the present invention will be described in detail. First, aluminum as a base is degreased and treated with an acid to roughen the surface thereof. Then, the aluminum phase is chemically oxidized with a mixture of an acid in a base phase to form a black aluminum oxide film. The surface modification is preferably performed such that the aluminum oxide has a thickness of 100 to 5,000 nm. If the thickness of the aluminum oxide is less than 100 nm, it is impossible to make the aluminum oxide surface sufficiently porous and rough. Meanwhile, if the thickness of the aluminum oxide exceeds 5,000 nm, the boundaries between pores on the aluminum oxide surface are weakened, and as a result, the aluminum oxide is likely to be peeled off from the surface.

The aluminum base having undergone degreasing and acid-base treatment is anodically oxidized. Specifically, the anodic oxidation is performed by applying a voltage of 30 to 40 V to the surface-modified aluminum base at a temperature of 10 to 20° C. for 10 to 40 minutes. The anodic oxidation enables penetration of a polymer into the metal surface in the subsequent step to improve the adhesive strength between the metal and the resin, achieving improved tensile strength of the composite while maintaining the tensile strength even after a thermal shock.

The method of the present invention may optionally further include thermally treating the aluminum oxide. The thermal treatment may be performed at an optimum temperature (preferably 200 to 300° C.) for an optimum time to allow the aluminum to exist in an oxidation state. The thermal treatment improves the adhesive strength between the metal and the resin, achieving improved tensile strength of the composite while maintaining the tensile strength even after a thermal shock.

Next, the aluminum oxide having undergone degreasing and anodic oxidation is treated with at least one surface modifier selected from the group consisting of sulfur-containing diazole derivatives, sulfur-containing diamine derivatives, sulfur-containing thiol derivatives, sulfur-containing pyrimidine derivatives, and sulfur-containing silane coupling agents. The sulfur-containing surface modifier may be polymerized into a polymer selected from: one-dimensional (linear) polymers, such as polymers of 2,5-dimercapto-1,3,4-thiadiazole derivatives, polymers of dithiopiperazine, and polymers of dimethylethylenediamine; two-dimensional (ladder) polymers, such as polymers of tetrathioethylenediamine and polymers of polyethyleneimine dithiol; three-dimensional (cross-linked) polymers, such as polymers of triazine thiol derivatives and polymers of 2,4-dithiopyrimidine derivatives; and polymers of mercaptopropylmethoxysilane, which have already been described.

The aluminum surface may be treated with the surface modifier containing S and N by two different methods: chemical and electrochemical methods.

According to the chemical method, the surface modifier is dissolved in a suitable organic solvent, including water, to prepare a solution having a predetermined concentration, and the solution is coated by a suitable technique such as spray coating, dip coating, flow coating or spin coating. The coating thickness is preferably from 100 nm to 5000 nm.

According to the electrochemical method, coating may be performed by repeatedly sweeping a potential in the range of −0.5 V to 2.0 V vs. SCE (cyclic voltammetry (CV)), applying a voltage between 3 V and 50 V (a constant voltage method), or scanning a current density of 0.1 mA to 30 mA (a constant current method).

As the solvent, there may be used, for example, methanol, ethanol or water. Various other solvent systems and mixed solvents may also be used. The processing of the film coated with the organic material into a polymer film facilitates bonding of the aluminum to a resin in the subsequent step. For polymerization, an initiator such as benzoyl peroxide (BPO) or azobisisobutyronitrile (AlBN) is dissolved at an appropriate concentration and added to the surface-modified aluminum, followed by UV irradiation, photo-curing, thermal treatment or electrochemical treatment.

Finally, a polymer resin is injection molded into various structures with desired shapes on the aluminum surface to which the surface modifier is applied. This injection molding is performed under appropriate temperature and pressure conditions.

The polymer resin is preferably selected from the group consisting of, but not limited to, polyphenylene sulfide (PPS), polybutylene terephthalate (PBT), polyimide (PI), liquid crystal polymers (LCPs), polyether ether ketone (PEEK), polyether ketone (PEK), ethylene propylene diene methylene rubber (EPDM), acrylic rubber (ACM), polypropylene/ethylene propylene diene methylene rubber (PP+EPDM), and mixtures thereof.

The polymer resin may also include, for example, an appropriate ceramic or glass fiber. The injection molding of the resin into various structures having desired shapes under appropriate temperature and pressure conditions enables high adhesive strength between the metal and the resin. The method of the present invention is distinguished from prior art methods in that processing steps such as pretreatment, appropriate surface roughening, thermal treatment, and surface coating are carried out to enhance the bonding strength to the resin. Due to this advantage, the method of the present invention can replace existing methods and is suitable for the production of a metal-resin composite with high bonding strength between the metal and the resin.

According to the method of the present invention, the coating with appropriate additives containing S, N and Si on the surface of aluminum enables the production of an aluminum-polymer resin composite that has improved adhesive strength between the metal and the resin, achieving improved tensile strength while maintaining the tensile strength even after a thermal shock.

### EXAMPLES

### Example 1

Aluminum (C1100) was surface modified with 20% HNO₃ (70%) and sandpaper (2500 mesh) and treated with an alkaline degreasing agent for 5 min. Thereafter, the degreased aluminum was primarily washed with acetone in an ultrasonic cleaner for 5 min, washed with distilled water, treated with a 10% M NaOH solution for 1 min, washed with distilled water, and treated with a 0.5 M H₂SO₄ solution at room temperature for 1 min to activate its surface. Subsequently, the surface-activated aluminum was anodically oxidized in 1 M oxalic acid at 10° C. and 30 V for 10 min.

FIGS. 2a and 2b are scanning electron microscopy (SEM) images showing the aluminum surface after the anodic oxidation. The images show that pores with a size of several nanometers were formed on the surface. A polymer resin penetrated into the pores in the subsequent step. This penetration is believed to improve the bonding strength between the polymer resin and the aluminum.

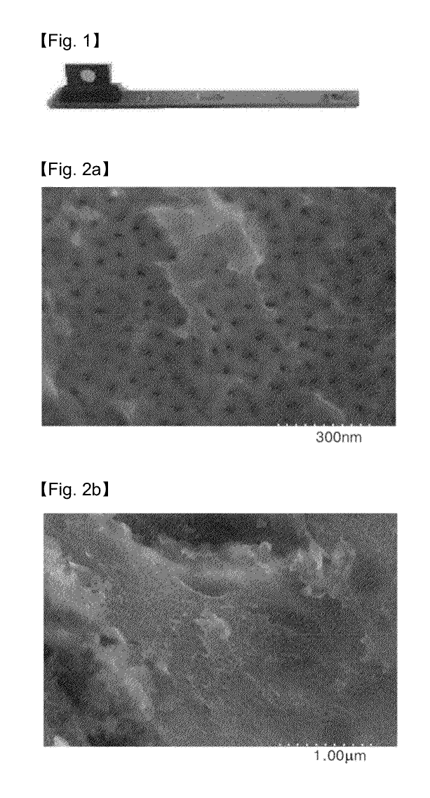

PPS (Ecotran SPA 2130G NC, SK Chemicals or TORELINA, TORAY) as the resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 10 cycles of the thermal shock test.

### Example 2

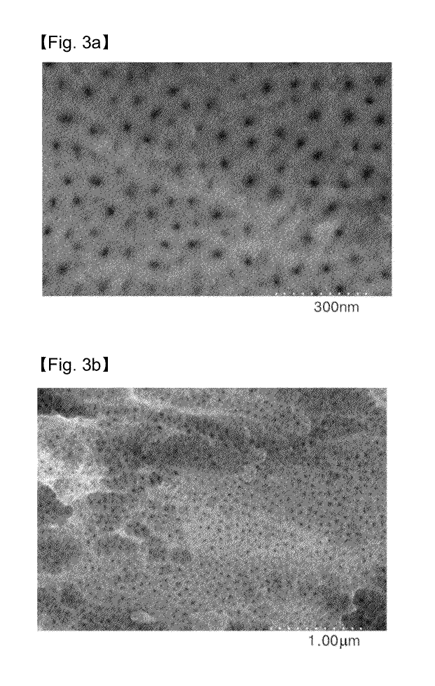

Aluminum was surface modified in the same manner as in Example 1, except that anodic oxidation was performed in 1 M oxalic acid at 10° C. and 40 V for 10 min. FIGS. 3a and 3b are scanning electron microscopy (SEM) images of the aluminum surface after the anodic oxidation. The aluminum surface shown in FIGS. 3a and 3b had larger nanopores and was smoother than that shown in FIGS. 2a and 2b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 15 cycles of the thermal shock test.

### Example 3

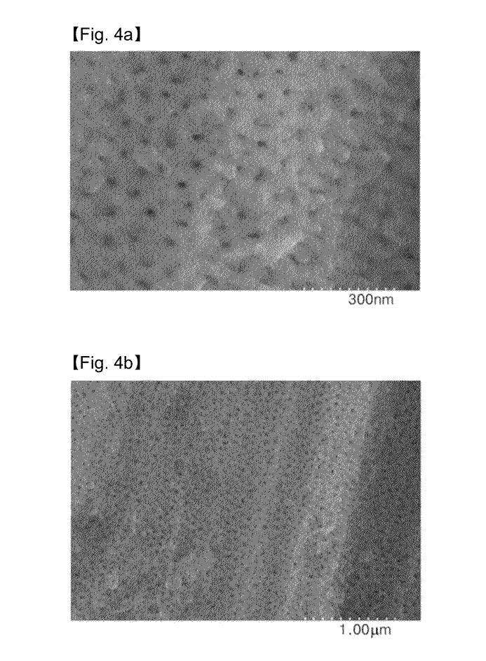

Aluminum was surface modified in the same manner as in Example 1, except that anodic oxidation was performed in 1 M oxalic acid at 10° C. and 40 V for 20 min. FIGS. 4a and 4b are scanning electron microscopy (SEM) images of the aluminum surface after the anodic oxidation. The aluminum surface shown in FIGS. 4a and 4b was similar to that shown in FIGS. 3a and 3b but was smoother and had larger pores with a size of several nanometers than that shown in FIGS. 3a and 3b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 20 cycles of the thermal shock test.

### Example 4

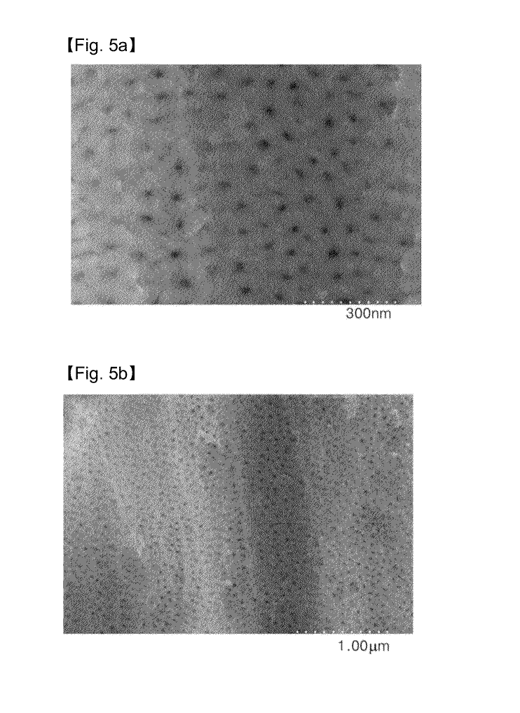

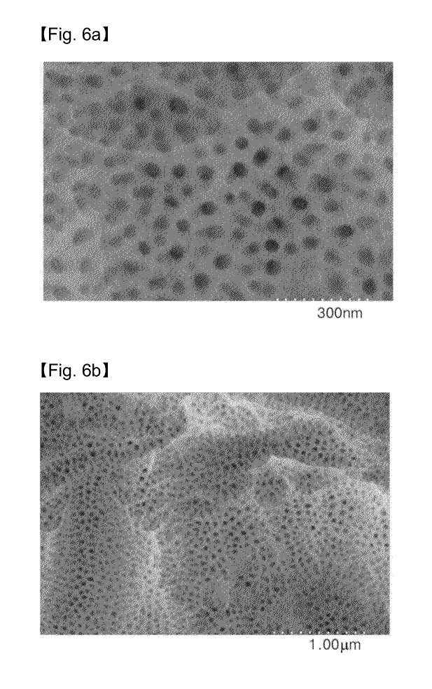

Aluminum was surface modified in the same manner as in Example 1, except that anodic oxidation was performed in 1 M oxalic acid at 10° C. and 40 V for 40 min. FIGS. 5a and 5b are scanning electron microscopy (SEM) images of the aluminum surface after the anodic oxidation. The aluminum surface shown in FIGS. 5a and 5b had larger pores with a size of several nanometers and was smoother than that shown in FIGS. 4a and 4b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 20 cycles of the thermal shock test.

### Example 5

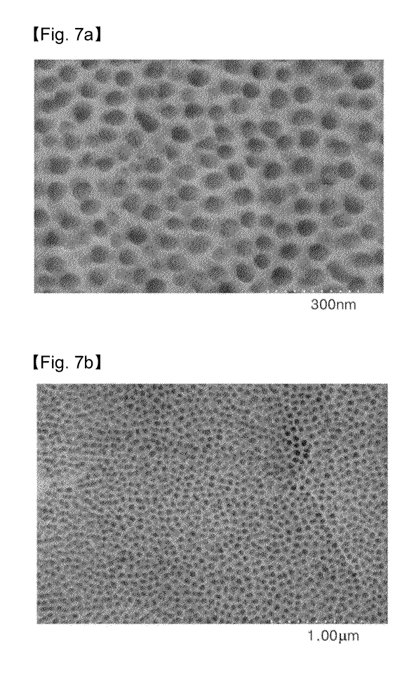

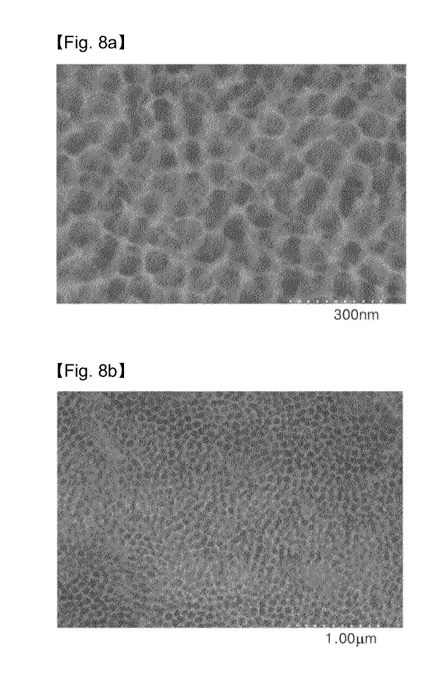

An aluminum base was surface modified in the same manner as in Example 3 and a 2,5-dimercapto-1,3,4-dithiadiazole derivative was electrochemically applied thereto at 10 V for 10 min. FIGS. 6a and 6b are scanning electron microscopy (SEM) images of the aluminum surface after the electrochemical application. Referring to these images, pores with a size of several nanometers were formed on the surface and the white organic material was applied thereto.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, no leakage was observed even after 70 cycles of the thermal shock test.

### Example 6

The procedure of Example 5 was repeated except that a 2,5-dimercapto-1,3,4-dithiadiazole derivative was electrochemically coated at 10 V for 20 min. FIGS. 7a and 7b are scanning electron microscopy (SEM) images of the aluminum surface after the electrochemical coating. The aluminum surface shown in FIGS. 7a and 7b had pores with a larger size and more uniformly coated with the 2,5-dimercapto-1,3,4-dithiadiazole derivative than that shown in FIGS. 6a and 6b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, no leakage was observed even after 100 cycles of the thermal shock test.

### Example 7

The procedure of Example 6 was repeated except that a 2,5-dimercapto-1,3,4-dithiadiazole derivative was electrochemically coated at 10 V for 40 min. FIGS. 8a and 8b are scanning electron microscopy (SEM) images of the aluminum surface after the electrochemical coating. The aluminum surface shown in FIGS. 8a and 8b had pores with a larger size and more uniformly coated with the 2,5-dimercapto-1,3,4-dithiadiazole derivative than that shown in FIGS. 7a and 7b. As can be seen from FIGS. 8a, and 8b, the boundaries between the pores collapsed. This pore distribution is believed to cause poor bonding strength to a polymer in the subsequent step.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, no leakage was observed even after 100 cycles of the thermal shock test.

### Example 8

Aluminum (C1100) was surface modified with 20% HNO₃ (70%) and sandpaper (2500 mesh) and treated with an alkaline degreasing agent for 5 min. Thereafter, the degreased aluminum was primarily washed with acetone in an ultrasonic cleaner for 5 min, washed with distilled water, treated with a 10% M NaOH solution for 1 min, washed with distilled water, and treated with a 0.5 M H₂SO₄ solution at room temperature for 1 min to activate its surface. The surface-activated aluminum was anodically oxidized in the same manner as in Example 3, and then 10% mercaptopropyltrimethoxysilane as a coupling agent was applied thereto for 20 min.

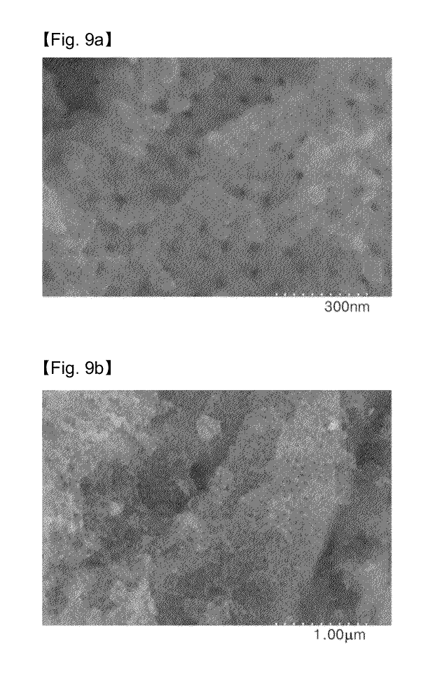

FIGS. 9a and 9b are scanning electron microscopy (SEM) images of the aluminum surface after the application of the coupling agent. These images show that the surface had no porous structure and was coated with the additive. It appears that there is a limitation in maintaining the bonding strength to a polymer in the subsequent step due to the absence of pores.

PPS (Ecotran SPA 2130G NC, SK Chemicals or TORELINA, TORAY) as the resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 60 cycles of the thermal shock test.

### Example 9

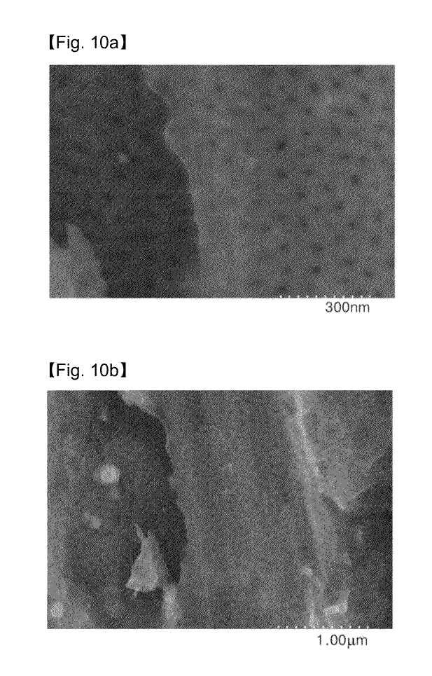

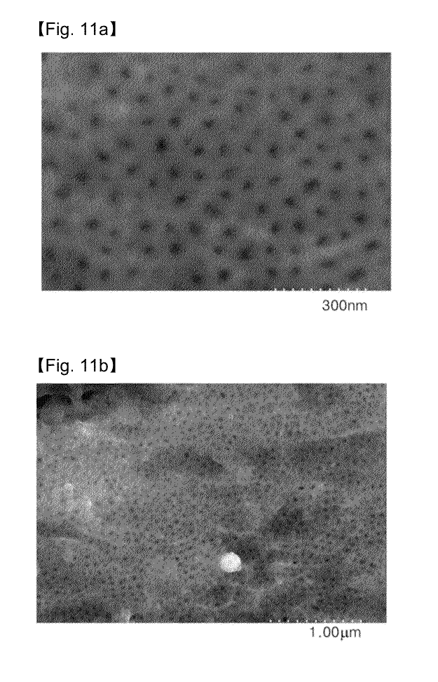

The procedure of Example 8 was repeated except that 10% mercaptopropyltrimethoxysilane as a coupling agent was applied at room temperature for 30 min. FIGS. 10a and 10b are scanning electron microscopy (SEM) images of the aluminum surface after the application of the coupling agent. These images show that the surface had no porous structure but was coated with the additive.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 70 cycles of the thermal shock test.

### Example 10

The procedure of Example 9 was repeated except that 10% mercaptopropyltrimethoxysilane as a coupling agent was applied at room temperature for 30 min and a 2,5-dimercapto-1,3,4-dithiadiazole derivative containing S and N was coated on the surface thereof for 10 min. FIGS. 11a and 11 b are scanning electron microscopy (SEM) images of the aluminum surface after the coating. The amount of the organic materials present on the aluminum surface shown in FIGS. 11a and 11b was larger than the amount of the organic material present on the aluminum surface shown in FIGS. 10a and 10b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, no leakage was observed even after 60 cycles of the thermal shock test.

### Example 11

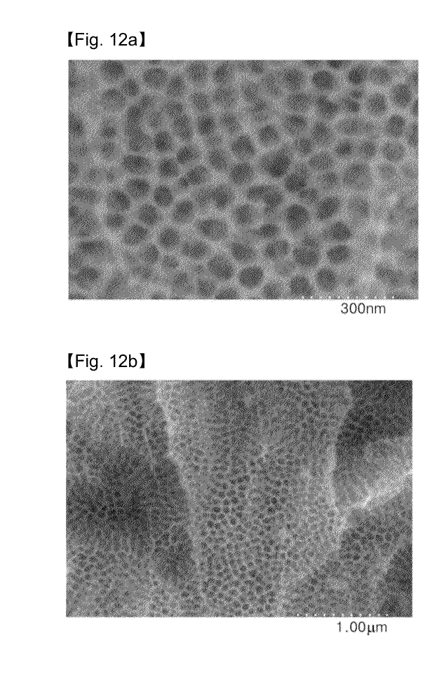

The procedure of Example 10 was repeated except that a 2,5-dimercapto-1,3,4-dithiadiazole derivative was coated for 30 min. FIGS. 12a and 12b are scanning electron microscopy (SEM) images of the aluminum surface after the coating. These images show the presence of the organic material.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, no leakage was observed even after 100 cycles of the thermal shock test.

### Comparative Example 1

Aluminum (C1100) was surface modified with 20% HNO₃ (70%) and sandpaper (2500 mesh) and treated with an alkaline degreasing agent for 5 min. Thereafter, the degreased aluminum was primarily washed with acetone in an ultrasonic cleaner for 5 min, washed with distilled water, treated with a 10% M NaOH solution for 1 min, washed with distilled water, and treated with a 0.5 M H₂SO₄ solution at room temperature for 1 min to activate its surface.

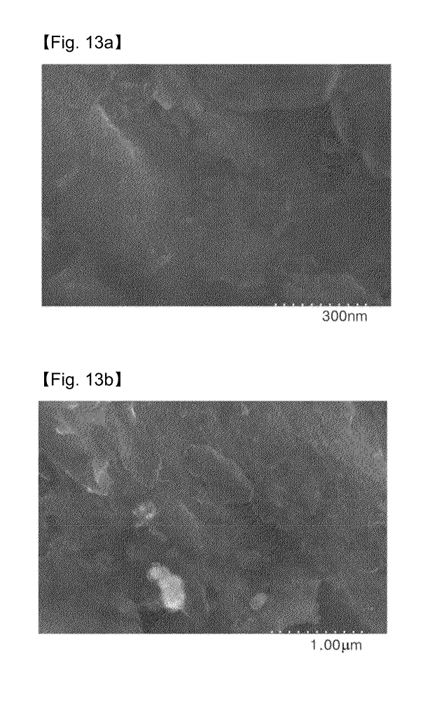

Subsequently, the surface-activated aluminum was coated with a 2,5-dimercapto-1,3,4-dithiadiazole derivative containing S and N for 5 min. FIGS. 13a and 13b are scanning electron microscopy (SEM) images of the aluminum surface after the coating. These images show that the surface had no porous structure and was coated with the additive. It appears that there is a limitation in maintaining the bonding strength to a polymer in the subsequent step due to the absence of pores.

PPS (Ecotran SPA 2130G NC, SK Chemicals or TORELINA, TORAY) as the resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 10 cycles of the thermal shock test.

### Comparative Example 2

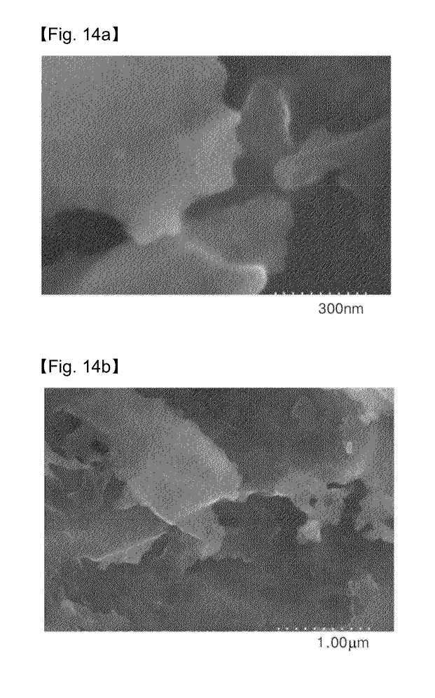

Aluminum was surface modified in the same manner as in Comparative Example 1. 10% mercaptopropyltrimethoxysilane as a coupling agent was applied to the surface-modified aluminum at room temperature for 30 min and a 2,5-dimercapto-1,3,4-dithiadiazole derivative containing S and N was coated on the surface thereof for 5 min. FIGS. 14a and 14b are scanning electron microscopy (SEM) images of the aluminum surface after the application of the 2,5-dimercapto-1,3,4-dithiadiazole derivative. These images show that the surface had no porous structure but was coated with the additive.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 50 cycles of the thermal shock test.

### Comparative Example 3

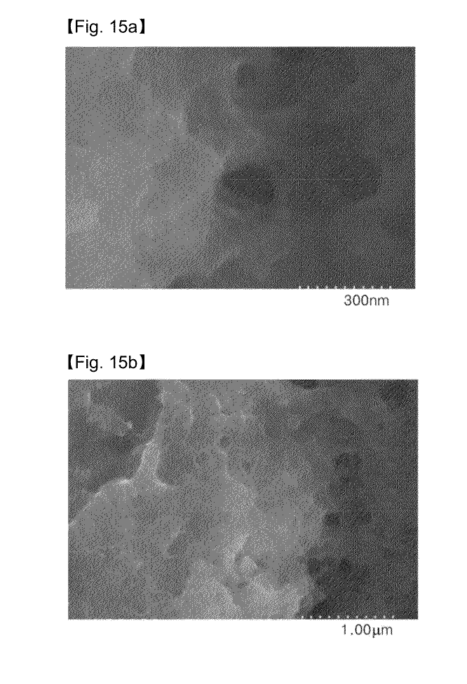

Aluminum was surface modified in the same manner as in Comparative Example 2. 10% mercaptopropyltrimethoxysilane as a coupling agent was applied to the surface-modified aluminum at room temperature for 30 min and a 2,5-dimercapto-1,3,4-dithiadiazole derivative containing S and N was coated on the surface thereof for 10 min. FIGS. 15a and 15b are scanning electron microscopy (SEM) images of the aluminum surface after the coating. The amount of the organic materials present on the aluminum surface shown in FIGS. 15a and 15b was larger than the amount of the organic material present on the aluminum surface shown in FIGS. 14a and 14b.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 60 cycles of the thermal shock test.

### Comparative Example 4

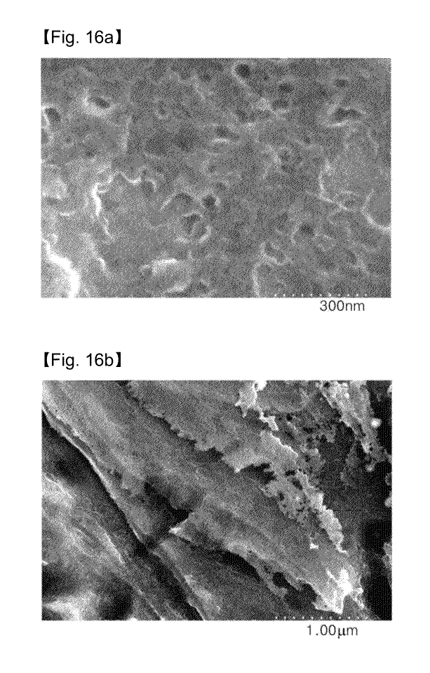

Aluminum was surface modified in the same manner as in Comparative Example 3. 10% mercaptopropyltrimethoxysilane as a coupling agent was applied to the surface-modified aluminum at room temperature for 30 min and a 2,5-dimercapto-1,3,4-dithiadiazole derivative containing S and N was coated on the surface thereof for 20 min. FIGS. 16a and 16b are scanning electron microscopy (SEM) images of the aluminum surface after the coating. These images show the presence of the organic materials.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 65 cycles of the thermal shock test.

### Comparative Example 5

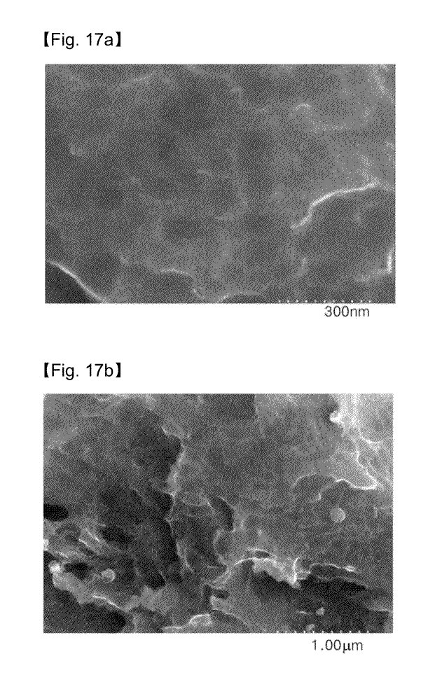

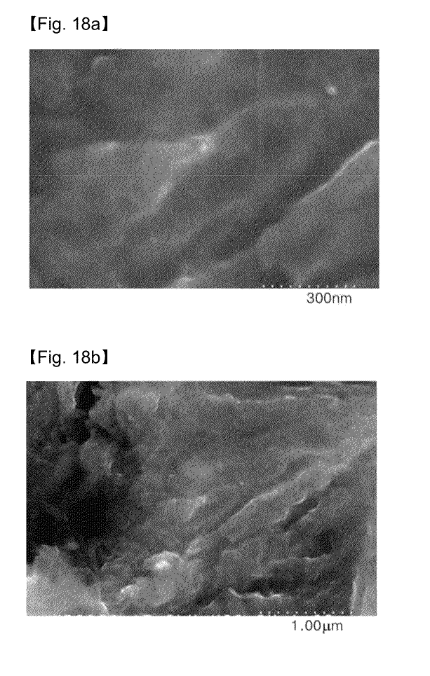

Aluminum (C1100) was surface modified with 20% HNO₃ (70%) and sandpaper (2500 mesh) and treated with an alkaline degreasing agent for 5 min. Thereafter, the degreased aluminum was primarily washed with acetone in an ultrasonic cleaner for 5 min, washed with distilled water, treated with a 10% M NaOH solution for 1 min, washed with distilled water, and treated with a 0.5 M H₂SO₄ solution at room temperature for 1 min to activate its surface. FIGS. 17a and 17b are scanning electron microscopy (SEM) images of the aluminum surface after the surface activation. As can be seen from these images, the aluminum surface cracked and had a somewhat rough shape, which was different from the shapes of the above samples having undergone two acid treatments, chemical oxidation, and thermal treatment.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after one cycle of the thermal shock test.

### Comparative Example 6

The procedure of Comparative Example 5 was repeated except that 10% mercaptopropyltrimethoxysilane as a coupling agent was applied at room temperature for 30 min. FIGS. 18a and 18b are scanning electron microscopy (SEM) images of the aluminum surface after the application of the coupling agent. Referring to these images, it can be confirmed that the silane organic material was applied to the surface.

PPS (Ecotran SPA 2130G NC, SK Chemicals or TORELINA, TORAY) as a resin was injection molded on the coated aluminum surface at a mold temperature of 175° C., a terminal temperature of 250° C., an injection temperature of 300° C., and a pressure of 50 kg/cm² to manufacture the structure shown in FIG. 1 in which the resin was bonded to the aluminum. A thermal shock test was conducted on the structure. In one cycle of the thermal shock test, the structure was held at a temperature of 100° C. for 30 min and a temperature of −40° C. for 30 min. This cycle was repeated. As a result, leakage was observed after 20 cycles of the thermal shock test.

The composites produced in Examples 1-11 and Comparative Examples 1-6 were analyzed by secondary ion mass spectrometry (SIMS). The composites were characterized based on the SIMS analysis data.

### Results of Secondary Ion Mass Spectrometry (SIMS) Analysis

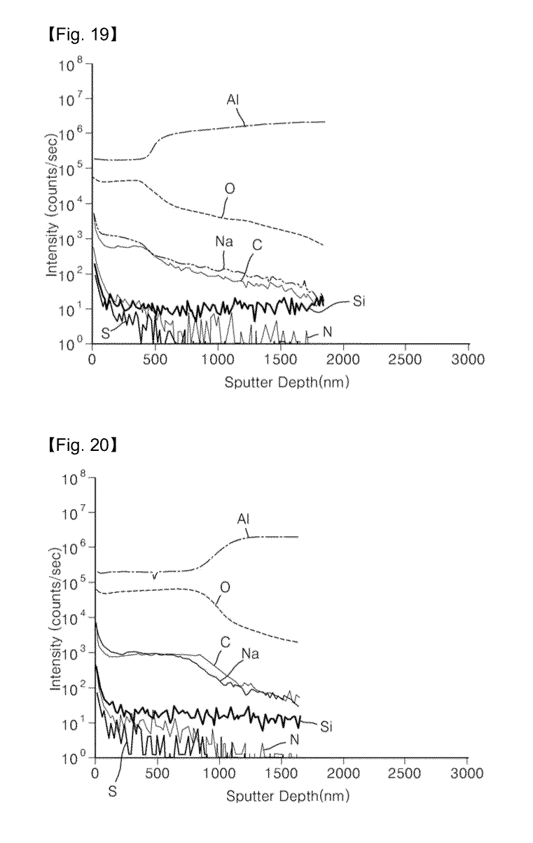

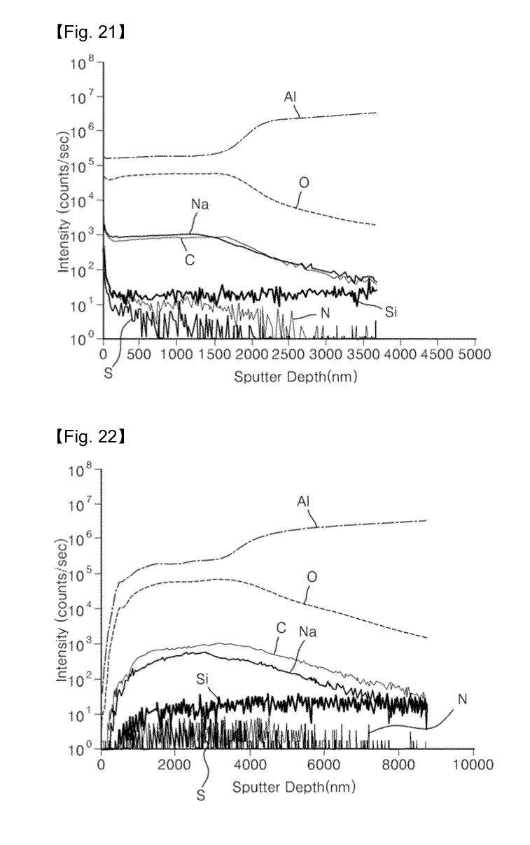

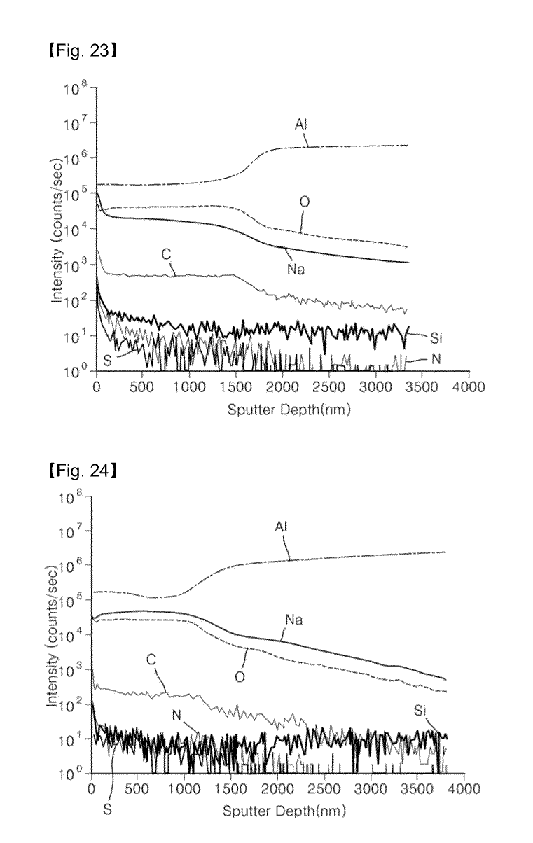

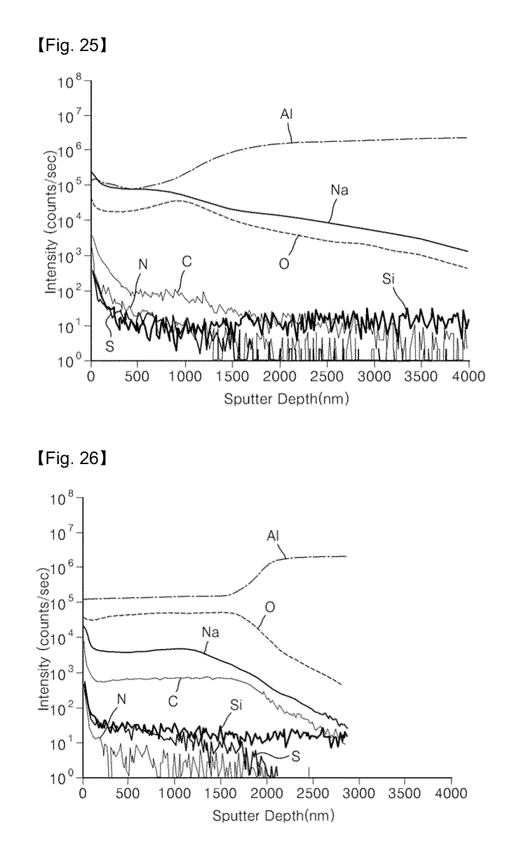

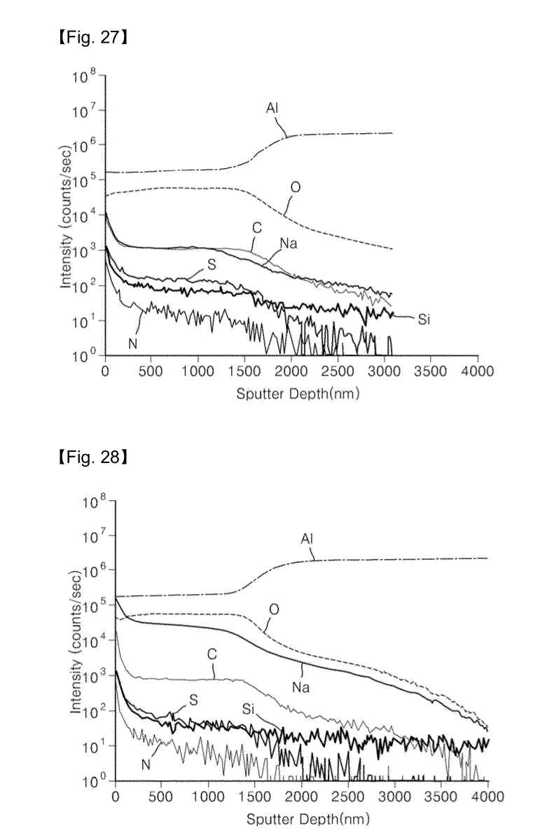

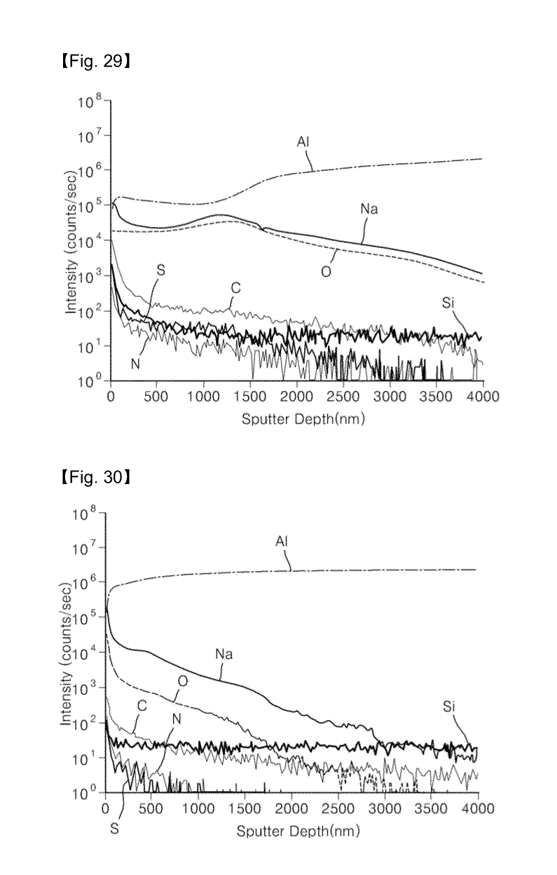

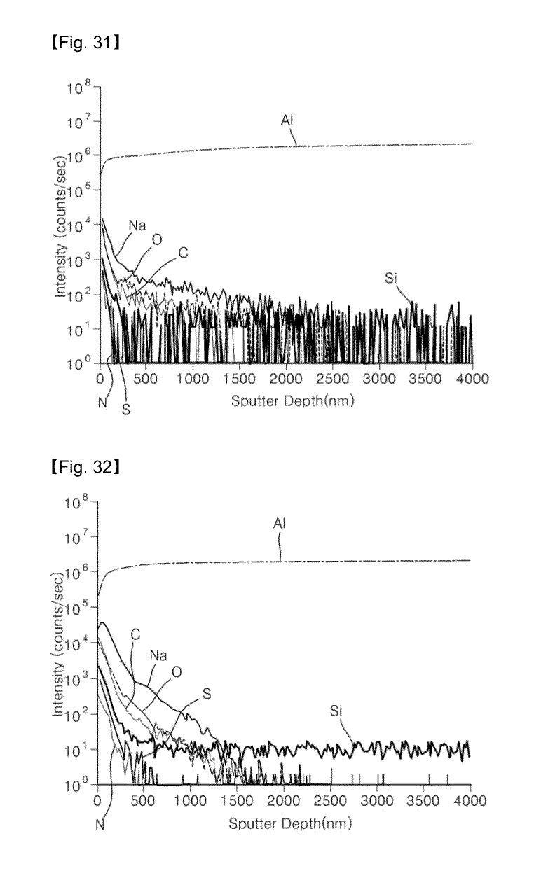

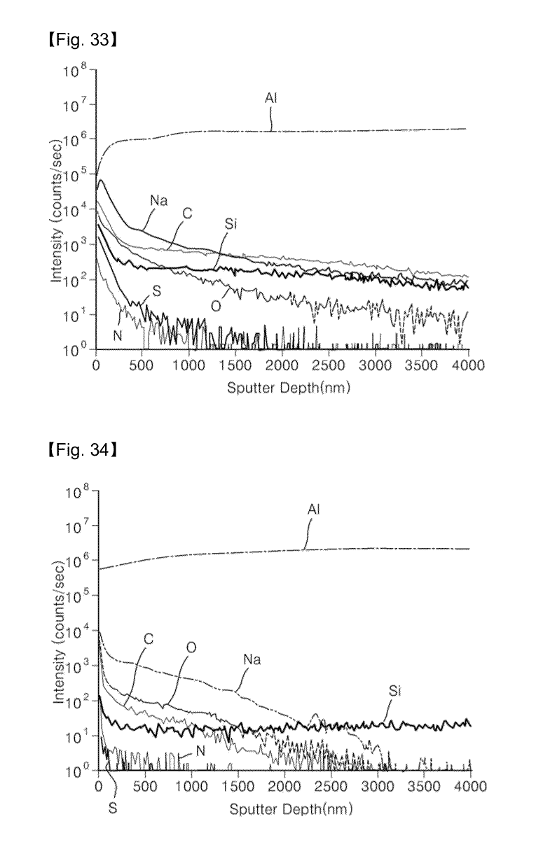

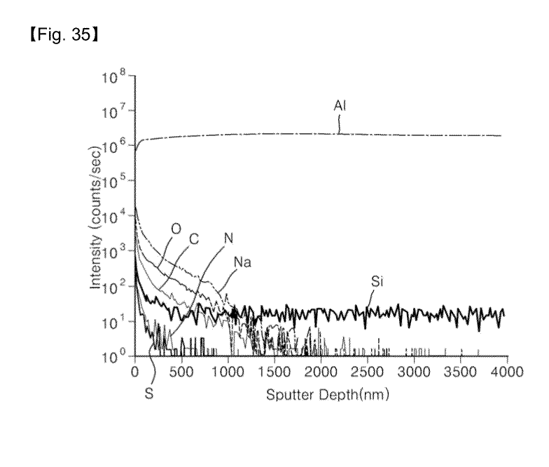

FIGS. 19 to 35 show the results of secondary ion mass spectrometry (SIMS) for the composites of Examples 1-11 and Comparative Examples 1-6, each of which was produced by surface modification of aluminum and application of the additive. The secondary ion mass spectrometry was conducted using an IMS-6f Magnetic Sector SIMS (CAMECA, France) under the following conditions: Cs⁺ Gun, Impact Energy=5.0 keV, Current=100 nA, Raster Size=200 μm×200 μm, analysis area=30 μm, Detected Ion: ¹³³Cs¹²C⁺, ¹³³Cs¹⁴N⁺, ¹³³Cs¹⁶O⁺, ¹³³Cs¹⁹F⁺, ¹³³Cs²³Na⁺, ¹³³Cs²⁷Al⁺, ¹³³Cs²⁹Si⁺, and ¹³³Cs³⁴S⁺.

The SIMS analysis could be performed to verify whether an oxide film represented by AlOₓ was formed on the surface after surface modification and anodic oxidation and whether the thickness of AlOₓ formed after anodic oxidation was in the range of 100 nm to 5,000 nm. The intensity ratios of C/Al, N/Al, O/Al, Na/Al, Si/Al, and S/Al of the aluminum-resin composites, each of which had a nanoporous AlOₓ structure on the aluminum surface, were measured to confirm the physical properties of the composites. The results are shown in Table 1.

TABLE 1

| | Ratio | | | | | |
|---|---|---|---|---|---|---|
| Sample No. | C/Al | N/Al | O/Al | Na/Al | Si/Al | S/Al |
| Example 1 | 3.36E−03 | 1.02E−04 | 2.48E−01 | 6.35E−03 | 8.20E−05 | 3.46E−05 |
| Example 2 | 4.28E−03 | 4.73E−05 | 3.02E−01 | 4.68E−03 | 9.23E−05 | 1.48E−05 |
| Example 3 | 4.09E−03 | 5.68E−05 | 2.98E−01 | 5.18E−03 | 9.60E−05 | 1.82E−05 |
| Example 4 | 3.69E−03 | 1.56E−05 | 2.95E−01 | 2.16E−03 | 6.63E−05 | 9.76E−06 |
| Example 5 | 2.67E−03 | 4.27E−05 | 2.28E−01 | 9.29E−02 | 1.19E−04 | 2.36E−05 |
| Example 6 | 1.37E−03 | 6.52E−05 | 2.04E−01 | 3.48E−01 | 6.34E−05 | 5.57E−05 |
| Example 7 | 1.60E−03 | 4.15E−04 | 2.37E−01 | 9.47E−01 | 1.65E−04 | 2.38E−04 |
| Example 8 | 4.38E−03 | 1.98E−05 | 3.07E−01 | 2.71E−01 | 1.49E−04 | 1.06E−04 |
| Example 9 | 5.95E−03 | 9.63E−05 | 2.96E−01 | 6.21E−03 | 4.17E−04 | 7.79E−04 |
| Example 10 | 3.99E−03 | 5.30E−05 | 2.78E−01 | 1.37E−01 | 2.17E−04 | 3.01E−04 |
| Example 11 | 1.16E−03 | 1.42E−04 | 1.79E−01 | 2.28E−01 | 3.56E−04 | 3.22E−04 |
| Comparative | 1.61E−05 | 1.79E−06 | 3.42E−02 | 4.29E−02 | 1.48E−05 | 8.79E−07 |
| Example 1 | | | | | | |
| Comparative | 6.90E−05 | 1.54E−06 | 1.27E−04 | 3.49E−04 | 1.33E−05 | 5.11E−06 |
| Example 2 | | | | | | |
| Comparative | 2.13E−05 | 4.53E−07 | 3.09E−05 | 2.30E−04 | 7.57E−06 | 9.65E−07 |
| Example 3 | | | | | | |
| Comparative | 6.34E−04 | 3.52E−06 | 2.70E−04 | 1.44E−03 | 1.91E−04 | 8.36E−06 |
| Example 4 | | | | | | |
| Comparative | 3.09E−05 | 1.16E−06 | 7.09E−05 | 6.18E−04 | 1.32E−05 | 3.59E−07 |
| Example 5 | | | | | | |
| Comparative | 1.91E−05 | 1.01E−06 | 6.24E−05 | 1.76E−04 | 1.04E−05 | 8.12E−07 |
| Example 6 | | | | | | |

Referring to the ratios shown in Table 1, it can be seen that a mixture of S, N, O, C, Na, Si, and P was diffused on the aluminum oxide. The intensity ratios of C/Al, N/Al, O/Al, Na/Al, Si/Al, and S/Al were in the range of 9.75×10⁻⁶ to 9.5×10⁻¹ at depths of 100 nm to 500 nm.

The thermal shock test results reveal that the composites of Examples 1-11 were more resistant to thermal shock than the composites of Comparative Examples 1-6, as mentioned above. These results lead to the conclusion that the inventive aluminum-polymer resin composites have improved tensile strength compared to the comparative composites.

Although the present invention has been described herein with reference to the foregoing embodiments, it will be understood by those skilled in the art that the invention can be implemented in other specific forms without changing the technical spirit or essential features of the present invention. Therefore, it should be noted that the forgoing embodiments are merely illustrative in all aspects and are not to be construed as limiting the invention.

The scope of the invention is indicated by the appended claims rather than the foregoing detailed description. All changes or modifications or their equivalents made within the meanings and scope of the claims should be construed as falling within the scope of the invention.

1. An aluminum-polymer resin composite comprising:
i) aluminum; and
ii) a polymer resin bonded to the aluminum after modification of the aluminum surface with a sulfur (S)-containing diazole derivative as a surface modifier,
wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS), and
the polymer resin is selected from the group consisting of polyphenylene sulfide (PPS), polybutylene terephthalate (PBT), polyimide (PI), liquid crystal polymers (LCPs), polyether ether ketone (PEEK), polyether ketone (PEK), ethylene propylene diene methylene rubber (EPDM), acrylic rubber (ACM), polypropylene/ethylene propylene diene methylene rubber (PP+EPDM), and mixtures thereof.

2. The aluminum-polymer resin composite according to claim 1, wherein the surface modifier is a 2,5-dimercapto-1,3,4-thiadiazole derivative.

3. The aluminum-polymer resin composite according to claim 2, wherein the 2,5-dimercapto-1,3,4-thiadiazole derivative is polymerized into a polymer represented by one of the following formulae: 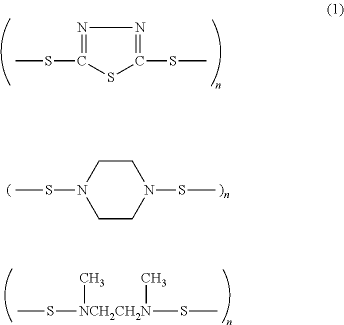
wherein each n is an integer from 10 to 100.

4. The aluminum-polymer resin composite according to claim 1, wherein the surface modification is performed such that an aluminum oxide having a thickness of 100 to 5,000 nm.

5. A method for producing an aluminum-polymer resin composite, the method comprising:
i) degreasing aluminum as a base and treating the degreased aluminum with an acid to roughen the aluminum surface;
ii) subjecting the surface-roughened aluminum to electrochemical anodic oxidation to form an appropriate nanoporous surface structure;
iii) applying to the aluminum oxide at least one surface modifier selected from the group consisting of sulfur-containing diazole derivatives; and
iv) injection molding a polymer resin on the surface-modified aluminum,
wherein the intensity ratios of C/Al, N/Al, O/Al, Na/Al, Si/Al, and S/Al in the composite are in the range of 9.75×10⁻⁶ to 9.5×10⁻¹ at depths of 100 nm to 500 nm, as analyzed by secondary ion mass spectrometry (SIMS), and
the polymer resin is selected from the group consisting of polyphenylene sulfide (PPS), polybutylene terephthalate (PBT), polyimide (PI), liquid crystal polymers (LCPs), polyether ether ketone (PEEK), polyether ketone (PEK), ethylene propylene diene methylene rubber (EPDM), acrylic rubber (ACM), polypropylene/ethylene propylene diene methylene rubber (PP+EPDM), and mixtures thereof.

6. The method according to claim 5, wherein the surface modifier is a 2,5-dimercapto-1,3,4-thiadiazole derivative.

7. The method according to claim 5, wherein the acid treatment is repeated twice.

8. The method according to claim 5, wherein the electrochemical anodic oxidation is performed at a voltage of 30 to 40 V for 10 to 40 minutes.
